(19) United States
(12) Patent Application Publication
(10) Pub. No.: US 2007/0078945 A1
(43) Pub. Date: Apr. 5, 2007

(54) SYSTEM AND METHOD FOR DISPLAYING INFORMATION OF A MEDIA PLAYING DEVICE ON A DISPLAY DEVICE

(76) Inventors: Kuan-Hong Hsieh, Shenzhen (CN); Xiao-Guang Li, Shenzhen (CN)

Correspondence Address: NORTH AMERICA INTELLECTUAL PROPERTY CORPORATION, P.O. BOX 506, MERRIFIELD, VA, 22116, US

(21) Appl. No.: 11/309,165

(22) Filed: Jul. 4, 2006

(30) Foreign Application Priority Data
Jul. 8, 2005 (CN) 200510035920.8

(51) Int. Cl. G06F 15/16

(52) U.S. Cl. 709/217

(57) ABSTRACT

A system for displaying information from a media playing device on a display device are provided. The system includes a media playing device (10) and a display device (20). The media playing device includes an network interface (103) for downloading network information from a network (40) and outputting the network information thereof. The display device is connected to the media playing device via a video interface and a audio frequency interface (AF), obtains and displays the network information. A related method is also provided.

### TECHNICAL FIELD

The present invention relates to systems and methods for displaying information from a media playing device on a display device, and more specifically, to a system and method for displaying network information from a network on a display device through a media playing device.

### GENERAL BACKGROUND

Advantages of a portable media playing device such as its small size, low energy consumption, and so on, have made it a popular choice amongst consumers. It can be used in a wide range of applications and its features are constantly developed to include colorful graphical interfaces, lyrics displays, and the like.

Yet, a conventional media playing device has no network interface, and cannot be used to download songs, listen to music online, see a movie online, or browse the web through a network, or the like. When consumer update songs, watch movies, read eBooks, and the like, the corresponding contents must be first downloaded from a network by a computer or other electronic devices, storing the contents therein, then copying the songs, movies, eBooks from therein into the media playing device, before the media device can broadcast or display corresponding contents according to the consumer operations.

Additionally, cost constraints on a control device of the media player have limited production resources on colors and resolution of the display screen, making the display screen unable to display detailed information.

The development on display technologies has been greatly improved with respect to color and resolutions on easily accessible display devices such as a home TV set. Therefore, developing a communication link between the media playing device and an easily accessible display unit will give consumers an addition display option with no additional costs.

### SUMMARY

A system for displaying information from a media playing device on a display device is provided. The system includes a media playing device and a display device connected to the media playing device through a video interface and an audio frequency (AF) interface. The display device obtains and displays image information from the media playing device.

A method for displaying information from a media playing device on a display device is also provided. The method includes the steps of: (a). receiving a mode switch command from the control device 30, and switches a display device to a music mode; (b). sending a control command to the media playing device; (c). responding to the control command and sends preset information including an IP address, a user ID, a password to the network 40 automatically, and enter into the object Web, obtains corresponding network information from the network 40 via the network interface 103; (d). obtaining the information of control interface from the data storage 104. (e). combining the information of control interface with the image information of the network information and produce a combined image information, and sending the combined image information to the display device 20, outputting the audio information of the network information to the display device 20; and (f). obtaining and displaying the combined image information and broadcast the audio information respectively.

A media playing device is further provided. The media playing device includes: a control input module for accepting a control command from a control device; a data storage for storing information, the information includes audio information, video information, image information, control interface information, and so on; a video interface for outputting image information to the display device; a AF interface for outputting audio information to the display device; a network interface for downloading the network information from the network; a display processing unit for processing the image information from the data storage or the network; an audio processing unit for processing the audio information from the data storage or the network; a micro controller unit (MCU) for controlling the media playing device to execute corresponding operations and output the media information of network information to the display device.

In virtue of the connecting of the media playing device with the display device, the customer can watch the media information obtained by the media playing device from a network fairly and expediently on the display device.

### BRIEF DESCRIPTION OF DRAWINGS

FIG.1 is a block diagram of a system for displaying information from a media playing device on a display device in accordance with a preferred embodiment of the present invention;

FIG. 2 shows a user interface shown on the display device when the displaying device obtains information from the media playing device; and

FIG. 3 is a flow chart of a preferred method for implementing the displaying of information from the media playing device on the display device of FIG. 1.

### DETAILED DESCRIPTION OF THE INVENTION

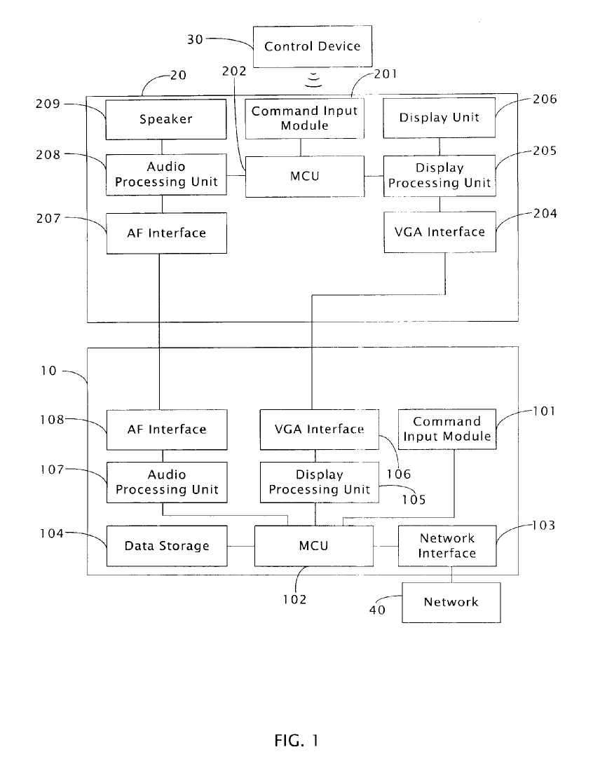

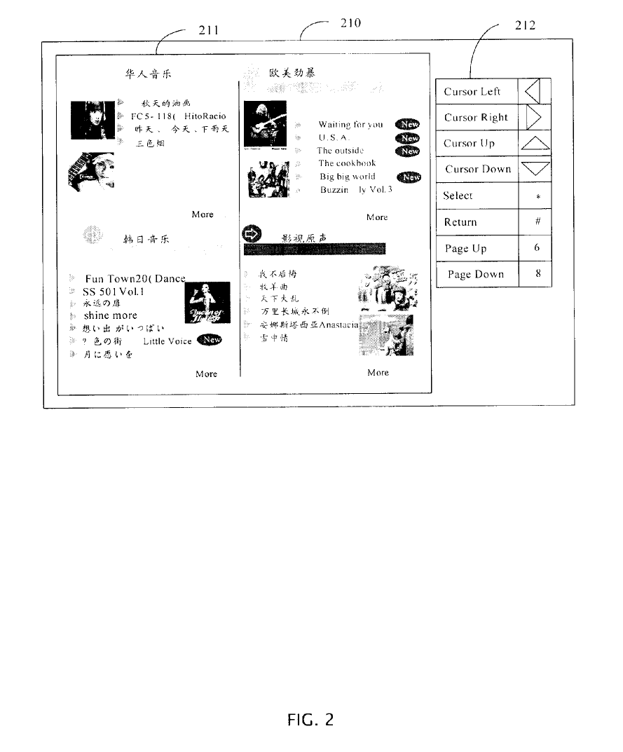

Referring to FIGS. 1 and 2, a media playing device 10 is connected between a network 40 and a display device 20. The media playing device 10 obtains network information including image information and audio information from the network 40 via a network interface 103 constructed therein and transmits the information to the display device 20 to display thereon via a video interface 204 and an audio frequency (AF) interface 207. The media playing device 10 and the display device 20 are both controlled by a control device 30 that is installed with a mode switch button (not shown). The control device 30 produces a mode switch command using the mode switch button, and switches the display device 20 between a normal display mode and a music mode according to the mode switch command. In the normal display mode, the display device 20 displays information from information sources other than the media playing device 10, and the control device 30 accordingly transmits commands to control the display device 20. Taking a television (TV) set as an example of the display device 20, the TV set displays information provided by TV stations when in the normal display mode. In the music mode, the display device 20 displays information provided by the media playing device 10, and the control device 30 accordingly transmits control commands to control the media playing device 10.

The display device 20 may be a cathode ray tube (CRT) monitor, a liquid crystal display (LCD), a CRT TV set, a liquid crystal TV set, etc. For simplicity, hereinafter a TV set is employed as the display device 20 to illustrate the preferred embodiment. However, it should be noted that the present invention should not be constructed as being limited to any concrete display device. Any display device capable of displaying media information can be employed as the display device 20. The TV set 20 mainly includes a command input module 201, a micro controller unit (MCU) 202, the video interface 204, such as a video graphics array (VGA) interface 204, a display processing unit 205, a display unit 206, the AF interface 207, an audio processing unit 208, and at least one speaker 209. The display device receives the image information and audio information from the media playing device 10 via the VGA interface 204 and the AF interface 207 respectively. The control input module 201 receives and processes the commands from the control device 30, and transmits the processed commands to the MCU 202. The MCU 202 accordingly executes an operation based on each command. For example, when receiving a mode switch command from the control input module 201, the MCU 202 switches the TV set 20 between the normal display mode and the music mode. The display processing unit 205 and the audio processing unit 208 respectively process the image information and the audio information from the media playing device 10, and then outputs the image information and the audio information respectively to the display unit 206 and the speaker 209 to broadcast.

The media playing device 10 mainly includes a control input module 101, a MCU 102, the network interface 103, a data storage 104, a display processing unit 105, a VGA interface 106, an audio processing unit 107, an AF interface 108. The media playing device 10 downloads network information from the network 40 via the network interface 103. The network information is stored in the data storage 104 under the control of the MCU 102. The network information is further transmitted to the TV set 20. The audio information of the network information is transmitted sequentially by the audio processing unit 107 and the AF interface 108 to the display device 20, and the image information of the network information is transmitted sequentially by the display processing unit 105 and the VGA interface to the display device 20. The data storage 104 stores control information as well as the network information downloaded from the network 40. The control information includes a control table 212. The control table 212 is shown on a screen of the TV set 20 when the TV set 20 is in music mode. The control table includes control commands such as a cursor down, a cursor up, a cursor left, a cursor right, a selection, a return, a page down, a page up, and etc, guiding users to operate the control device 30. The network information downloaded from the network 40 includes a current user interface, songs, and images etc, of a Web site.

The control input module 101 receives and outputs the control commands from the control device 30 to the MCU 102 when the TV set 20 is in the music mode. The control commands includes a download control command that is produced by a download control button (not shown) of the control device 30. The MCU 102 responds to the download control commands and determines whether the network interface 103 is present or not. If the network interface 103 is present, the MCU 102 automatically sends preset information stored in the data storage 104, including an IP address, a user ID, a password, to the network 40 via the network interface 103. The MCU 102 obtains the network information from a Web site corresponding to the IP address via the network interface 103, and stores the network information in the data storage 104 as well as outputting the network information to the TV set 20 to broadcast.

A current user interface 211 of the Web site (a example is given as a user interface 211 shown in FIG. 2) is combined with the command table 212 and is coordinately displayed on the screen 210 with the command table 212. The users operate the user interface 211 with the control device 30 as the command table 212 indicates. For example, the users may utilizes a cursor left button, a cursor right button, a cursor up button and a cursor down button of the control device 30 to highlight a media file and utilizes a select button to select the media file via the user interface 211 to browse the media file via the TV set 20.

In addition, in an alternative embodiment, digital vision interface (DVI) interfaces can be employed to replace the VGA interfaces 106 and 204 to transmit image information between the media playing device 10 and the display device 20.

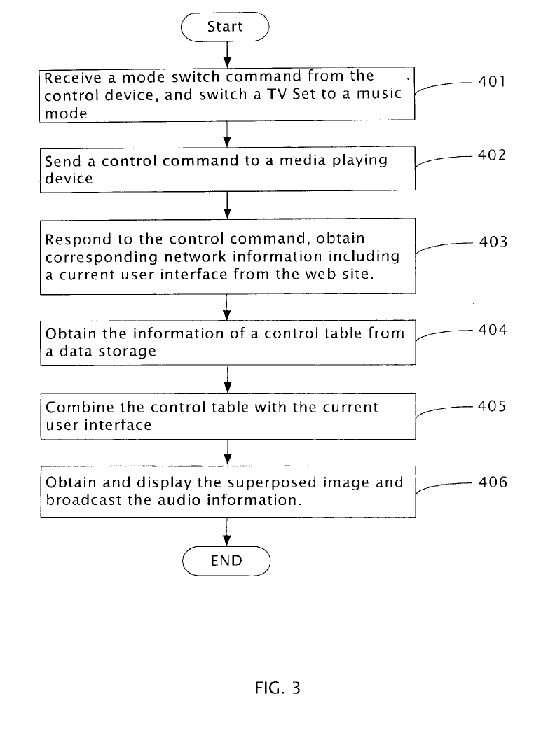

FIG. 3 is a flow chart of a preferred method for implementing information display utilizing the system of FIG. 1. In step 401, the TV set 20 receives the mode switch command from the control device 30, and switches itself to the music mode in accordance with the mode switch command. In step 402, the control device 30 sends a download control command to the media playing device 10. In step 403, the media playing device 10 responds to the download control command, automatically sends preset information stored in a data storage 104, including an IP address, a user ID and a password to the network 40, and obtains network information including a current user interface from a Web site corresponding to the IP address via the network interface 103. In step 404, the MCU 102 obtains a control table 211 from the data storage 104. In step 405, the MCU 102 combine the control table 211 with the current user interface of the Web site to produce a combined image and sends the combined image together with audio information of the network information to the display device 20. In step 406: The display device 20 displays the combined image information and broadcast the audio information.

What is claimed is:

1. A system for displaying information, the system comprising:
a media playing device, comprising:
a network interface for downloading network information from a network, the network information comprising image information; and
a video interface for outputting the image information; and
a display device connected to the media playing device via the video interface, configured for displaying the image information from the media playing device.

2. The system as claimed in claim 1, further comprising a control device, the control device producing a mode switch command to control the media playing device to switch between a normal display mode and a music mode.

3. The system as claimed in claim 2, wherein the display device displays the image information from the media playing device in the music mode and the control device accordingly transmits control commands to control the media playing device.

4. The system as claimed in claim 3, wherein the control commands comprises a download control command, the download control command controlling the media playing device to download the network information.

5. The system as claimed in claim 4, wherein the media playing device sends preset information including an IP address to the network in accordance with a download control command.

6. The system as claimed in claim 5, wherein the media playing device downloads the network information from a Web site corresponding to the IP address.

7. The system as claimed in claim 3, wherein the media playing device stores a control table, combines the control table with the image information to produce a combined image, and transmits the combined image to the display device to display.

8. The system as claimed in claim 7, wherein the control table guides the control device to produce corresponding control commands.

9. The system as claimed in claim 3, wherein the media playing device further comprises an input control module for receiving the control commands from the control device.

10. The system as claimed in claim 1, wherein the media playing device further comprises an audio interface electrically connected to the display device.

11. The system as claimed in claim 10, wherein the network information further comprises audio information, the audio information being transmitted to the display device by the media playing device via the audio interface.

12. The system as claimed in claim 11, wherein the display device further comprises at least one speaker for broadcasting the audio information.

13. A method for displaying information, the method comprising the steps of: connecting a media playing device with a display device and a network respectively via a video interface and a network interface;
commanding the media playing device to download network information from the network via the network interface, the network information comprising image information;
responding to the command of the media playing device and sending an IP address to the network;
downloading the network information from a web site corresponding to the IP address;
obtaining a control table from a data storage of the media playing device combining the control table with the image information and producing a combined image; and
transmitting the combined image via the video interface to the display device to display.

14. The method as claimed in claim 13, wherein the network information further comprise audio information.

15. The method as claimed in claim 14, further comprising the step of connecting the media playing device with the display device via the audio interface.

16. The method as claimed in claim 15, further comprising the step of: transmitting the audio information via the audio interface to the display device to broadcast.

17. A media playing device comprising:
a data storage for storing a control table;
a network interface for downloading network information including image information from a network;
a MCU for combining the image information with the control table to produce a combined image; and
a video interface for outputting the combined image to a display device to display.

18. The media playing device as claimed in claimed 17, wherein the display device comprises at least one speaker.

19. The media playing device as claimed in claim 18, wherein the network information further comprises audio information.

20. The media playing device as claimed in claim 19, further comprising an audio interface for outputting the audio information to the display device to broadcast.
